(19) United States
(12) Patent Application Publication
(10) Pub. No.: US 2026/0269747 A1
(43) Pub. Date: Sep. 10, 2026

(54) A CONVERTER STATION AND A METHOD FOR CONTROLLING A CONVERTER STATION

(71) Applicant: Hitachi Energy Ltd, Zürich (CH)

(72) Inventors: Ying-Jiang HAFNER, Ludvika (SE); Khirod KUMAR-NAYAK, Odisha (IN); Malaya Kumar SAHU, Ludvika (SE); Adil ABDALRAHMAN, Örebro (SE); Ashkan NAMI, Västerås (SE)

(21) Appl. No.: 19/166,331

(22) PCT Filed: Feb. 1, 2024
(86) PCT No.: PCT/EP2024/052464

§ 371 Date: Sep. 17, 2025

(30) Foreign Application Priority Data
Mar. 31, 2023 (EP) 23165757.8

(51) Int. Cl. H02M 7/797; H02J 3/36; H02M 1/00

(52) U.S. Cl. CPC H02M 7/797; H02J 3/36; H02M 1/0025; H02J 2003/365

(57) ABSTRACT

A converter station comprises at least a first voltage source converter and a second voltage source converter. The converter station is configured to be connected to a direct current (DC) system and alternating current (AC) system. The converter station further comprises converter control units connected to the first voltage source converter and to the second voltage source converter, respectively. The converter control units obtain phase currents of the first and second voltage source converters, respectively. Each converter control unit comprises a damping controller, which comprises a regulator. The damping controllers determine current differences between the phase currents of the two converter stations and generate damping control signals by means of the regulators, which multiply the current differences with a gain to generate damping control signals. The converter control units combine the damping control signals with respective converter reference voltages, thereby providing modified converter reference voltages for the voltage source converters.

### TECHNICAL FIELD

The present disclosure generally relates to the field of converters in electric power systems. In particular, it relates to a converter station comprising at least two voltage source converters, as well as a method and a computer program product for controlling the converter station.

### BACKGROUND

The converter station or HVDC converter station is a type of substation that forms a terminal equipment for a high-voltage direct current (HVDC) transmission line. Converter stations are often used for converting alternating current (AC) to direct current (DC) or vice versa, for example, for converting between three-phase AC and DC.

The converter station comprises at least two converters. The converter station is configured to be connected to a DC system and to an AC system. The DC system may be a bipolar DC system, i.e. a system comprising two DC poles. The first voltage source converter and the second voltage source converter of the at least two converters are connected to the respective one of the two poles and to each other. The two converters are connected to the same AC system, the two poles share the active power via a power frequency droop. They also share the AC voltage control via a voltage-reactive power droop.

The main advantage of operating both converters in this arrangement is that the two poles can automatically share the active power imbalance during grid restoration, or active power generated by wind farms, because of the power frequency droop functionality.

However, when both the converters are interconnected on the AC side, there is a risk of oscillations between the two poles.

For example, if the converter station is a black starting station in which both converters are connected to a further supporting station via the DC system it is possible that the two converters start to oscillate against each other.

Typically, the oscillation is caused by lack of coordination between the two converters. Both the converters act as a voltage source trying to maintain the voltage of the same node.

### SUMMARY

Thus, it would be advantageous to achieve a method and a device to overcome, or at least alleviate, the above-mentioned drawbacks. In particular, it would be desirable to enable efficient damping of oscillations generated between the converters of the two poles. To better address one or more of these concerns, a method, a converter station, and a computer program product having the features defined in the independent claims are provided. Preferable embodiments are defined in the dependent claims.

Hence, according to a first aspect, a converter station is provided comprising at least two converters, including a first voltage source converter and a second voltage source converter. The converter station is configured to be connected to a direct current (DC) system and to an alternating current (AC) system. The DC system has two poles and the AC system has multiple phases. The first voltage source converter and the second voltage source converter are connectable to a respective one of the two poles and are also connected to each other. The converter station further comprises a first converter control unit and a second converter control unit connected to the first voltage source converter and to the second voltage source converter, respectively. The first converter control unit and the second converter control unit are configured to obtain phase currents of the first voltage source converter and phase currents of the second voltage source converter. The first converter control unit and the second converter control unit further comprise a first damping controller and a second damping controller, respectively. Each one of the first damping controller and the second damping controller comprises a regulator. The first damping controller is configured to determine first current differences between the phase currents of first and second voltage source converters. The second damping controller is configured to determine second current differences between the phase currents of first and second voltage source converters. The first and second damping controllers are configured to multiply the first current differences and the second current differences, respectively, with a respective gain for generating first damping control signals and second damping control signals, respectively. The gain is introduced by means of the regulator. The first converter control unit is further configured to combine the first damping control signals with a converter reference voltage of the first voltage source converter, in order to provide modified converter reference voltages for the first voltage source converter. The second converter control unit is further configured to combine the second damping control signals with a converter reference voltage of the second voltage source converter, in order to provide modified converter reference voltages for the second voltage source converter.

An advantage associated with the present disclosure is that the first converter control unit and the second converter control unit enable efficient damping of oscillations generated between the converters of the two poles in the converter station by modifying the converter reference voltages as defined.

The term converter station, or HVDC converter station, is a type of substation which forms the terminal equipment for a high-voltage direct current transmission line. The converter station comprises converters. In addition, the converter station may further comprise, for example, AC switch gear, DC switch gear, transformer, capacitors, filters.

The terms first damping controller and the second damping controller are used for controllers, like, P, PI, or PID controller. The first damping controller and the second damping controller are configured to determine the deviation in the converter station and generate the first damping control signals and the second damping control signals to eliminate or reduce the deviation in the converter station. Thereby, they reduce or eliminate the oscillations in the converter station. The first damping controller and the second damping controller may be separate units or an integrated unit of a damping controller comprising both the first damping controller and the second damping controller.

The term gain is to be understood as a variable relation between a current, and more particularly a current difference, and a voltage, thus resembling a virtual resistance. The gain is introduced by means of the regulator. Each of the damping controllers comprises the regulator. For example, the gain is the proportional gain in the case of the proportional (P) controller.

The first damping controller may be configured to determine the first current differences by subtracting the phase currents of the second voltage source converter from the phase currents of the first voltage source converter, and the second damping controller may be configured to determine the second current differences by subtracting the phase currents of the first voltage source converter from the phase currents of the second voltage source converter.

The first and second damping controllers in the converter station may be configured to operate in a DQ frame. The first damping controller further may be configured to determine the first current differences by operating on respective D current components and Q current components of the phase currents of the first and the second voltage source converters. Similarly, the second damping controller may further be configured to determine the second current difference by operating on respective D current components and Q current components of the phase currents of the second and the first voltage source converters. Thereby, the first and second current differences comprise D and Q difference current components. The first current differences may be determined as the D and Q current components of the phase currents of the second voltage source converter subtracted from the D and Q current components, respectively, of the phase currents of the first voltage source converter. Similarly, the second current differences may be determined as the D and Q current components of the phase currents of the first voltage source converter subtracted from the D and Q current components, respectively, of the phase currents of the second voltage source converter.

The first and second damping controllers may be configured to multiply the D and Q difference current components with the respective gain provided by the regulators to generate the respective first and second damping control signals in the DQ frame. The regulators of the first damping controller and the second damping controller may be configured to have equal gain. However, a skilled person will understand that it is possible to use different gains for the first damping controller and for the second damping controller.

The first converter control unit in the converter station may be configured to combine the first damping control signals in the DQ frame with corresponding components of the converter reference voltage for the first voltage source converter in order to provide the modified converter reference voltages for the first voltage source converter. The second converter control unit in the converter station may be configured to combine the second damping control signals in the DQ frame with corresponding components of the converter reference voltage for the second voltage source converter in order to provide the modified converter reference voltages for the second voltage source converter.

The first and second damping controllers in the converter station may be configured to operate in an ABC frame, i.e. to operate directly on the phase currents. The first damping controller may be configured to determine the first current differences and the second damping controller further may be configured to determine the second current differences by operating on respective A current components, B current components and C current components of the phase currents of the first and the second voltage source converters. The first current difference may be determined as the A, B and C current components of the phase current of the second voltage source converter subtracted from the A, B and C current components, respectively, of the phase currents of the first voltage source converter. Similarly, the second current differences may be determined as the A, B and C current components of the phase currents of the first voltage source converter subtracted from the A, B and C current components, respectively, of the phase currents of the second voltage source converter.

The first and second damping controllers may be configured to multiply the A, B and C difference current components with the respective gain provided by the regulators to generate the respective first and second damping control signals in the ABC frame. The regulators of the first damping controller and the second damping controller may be configured to have equal gain. However, the person skilled in the art will understand that it is possible to use different gains for the first damping controller and for the second damping controller.

The first converter control unit and the second converter control unit in the converter station may be configured to combine the A, B, and C components of the first damping control signals with the corresponding components of the converter reference voltage for the first voltage source converter in order to provide the modified converter reference voltages for the first voltage source converter. The second converter control unit in the converter station may be configured to combine 10 the A, B, and C components of the second damping control signals with corresponding components of the converter reference voltage in the ABC frame for the second voltage source converter in order to provide the modified converter reference voltages for the second voltage source converter.

According to a second aspect, a method is provided for controlling a converter station comprising at least two converters, including a first voltage source converter and a second voltage source converter. The converter station is configured to be connected to a DC system and to an AC system. The DC system has two poles and the AC system has multiple phases. The first voltage source converter and the second voltage source converter are connectable to a respective one of the two poles 20 and are connected to each other. The method comprises obtaining phase currents of the first voltage source converter and phase currents of the second voltage source converter; and determining first current differences between the phase currents of the first and second voltage source converters, and second current differences between the phase currents of the first and second voltage source converters. The method further comprises multiplying each of the first current differences and the second current differences, respectively, with a respective gain for generating first damping control signals and second damping control signals, respectively; and combining the first damping control signals with a converter reference voltage of the first voltage source converter and combining the second damping control signals with a converter reference voltage of the second voltage source converter, thereby providing respective modified converter reference signals for the first voltage source converter and the second voltage source converter.

The method may comprise determining the first current differences by subtracting the phase currents of the second voltage source converter from the phase currents of the first voltage source converter; and determining the second current differences by subtracting the phase currents of the first voltage source converter from the phase currents of the second voltage source converter.

The method for controlling a converter station may comprise determining DQ frame components of the phase currents, in particular determining the D current component and Q current component of the phase currents of the first voltage source converter, and determining the D current component and Q current component of the phase currents of the second voltage source converter. Then, the first current differences and the second current differences are determined by operating on respective D current components and Q current components of the phase currents of the first and the second voltage source converters. Determining the differences may comprise determining the first current differences between the D current components of the phase currents and between the Q current components of the phase currents to generate the first damping control signal for each component. Determining the differences may further comprise determining the second current differences between the D components of the phase currents and between the Q components of the phase currents to generate the second damping control signal for each component. The combining may comprise, for each component in the DQ frame combining the respective D and Q components of the first and second damping control signals with corresponding D and Q components of the respective first and second converter reference voltages in the DQ frame to provide the respective modified converter reference signals in the DQ frame for the first voltage source converter and the second voltage source converter.

The method for controlling a converter station, wherein combining D and Q components of the first damping control signal in DQ frame with D and Q components of the converter reference voltage of the first voltage source converter may comprise adding the D and Q components of the first damping control signal in the DQ frame to the D and Q components of the converter reference voltage in the DQ frame, and wherein combining the D and Q components of the second damping control signal in DQ frame with D and Q components of the converter reference voltage of the second voltage source converter may comprise adding the D and Q components of the second damping control signal in the DQ frame to the D and Q components of the converter reference voltage in the DQ frame.

The method for controlling a converter station, may comprise determining the first current differences and the second current differences by operating on respective A current components, B current components and C current components of the phase currents of the first and the second voltage source converters. The first current differences may be determined as the A, B and C current components of the phase currents of the second voltage source converter being subtracted from the A, B and C current components, respectively, of the phase currents of the first voltage source converter. The second current differences may be determined as the A, B and C current components of the phase currents of the first voltage source converter being subtracted from the A, B and C current components, respectively, of the phase currents of the second voltage source converter. The combining may comprise combining the respective A, B and C components of the damping control signals with corresponding A, B and C components of the respective converter reference voltage.

The method for controlling the converter station, wherein the operation of multiplying each of the first current differences and the second current differences, respectively, with a respective gain further comprises applying an equal gain. However, a skilled person will understand that it is possible to use different gains for generating the first damping control signal and the second damping control signal.

According to a third aspect there is provided a computer program product comprising computer readable instructions which, when executed by a device having processing capability, causes the device to carry out the method of the second aspect.

### BRIEF DESCRIPTION OF THE DRAWINGS

These and other aspects will now be described in more detail with reference to the appended drawings showing embodiments.

FIG. 1 schematically shows a converter station comprising two converters;

FIGS. 2a and 2b schematically show a first damping controller and a second damping controller respectively, when configured to operate in an ABC frame;

FIGS. 3a and 3b schematically show a first converter control unit and a second converter control unit configured to determine modified converter reference voltages in the ABC frame for the first voltage source converter and the second voltage source converter, respectively;

FIGS. 4a and 4b schematically show a first damping controller and a second damping controller respectively, when configured to operate in a DQ frame;

FIGS. 5a and 5b schematically show a first converter control unit and a second converter control unit configured to determine modified converter reference voltages in the DQ frame for the first voltage source converter and the second voltage source converter, respectively;

FIG. 6 schematically shows a converter;

FIG. 7 shows a flow chart for a method for controlling a converter station comprising at least two converters;

FIG. 8 illustrates a computer program product.

All the figures are schematic, not necessarily to scale, and generally only show parts which are necessary in order to elucidate the embodiments, wherein other parts may be omitted or merely suggested. Like reference numerals refer to like elements throughout the description.

### DETAILED DESCRIPTION

The present aspects will now be described more fully hereinafter with reference to the accompanying drawings, in which currently preferred embodiments are shown. These aspects may, however, be embodied in many different forms and should not be construed as limited to the embodiments set forth herein; rather, these embodiments are provided for thoroughness and completeness, and fully convey the scope of the present aspects to those skilled in art.

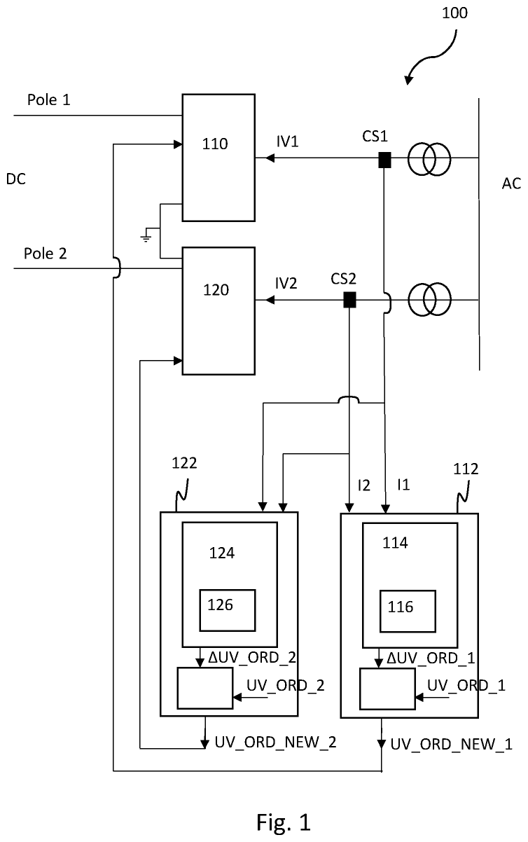

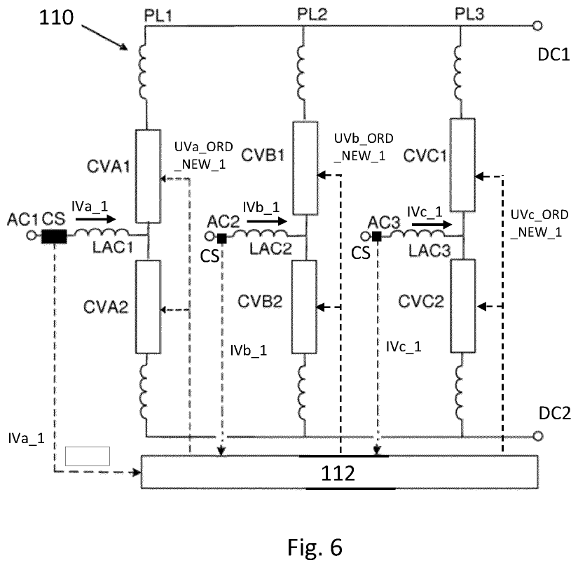

Referring to FIG. 1, according to an embodiment thereof a converter station 100 comprises two converters, including a first voltage source converter 110 and a second voltage source converter 120. The converter station 100 is configured to be connected to a direct current (DC) system and to an alternating current (AC) system. The DC system has two poles and the AC system has multiple phases. The first voltage source converter 110 and the second voltage source converter 120 are connectable to a respective one of the two DC poles, i.e., Pole 1 and Pole 2. The first voltage source converter 110 and the second voltage source converter 120 are also connected to each other. The converter station 100 further comprises a first converter control unit 112 and a second converter control unit 122 connected to the first voltage source converter 110 and to the second voltage source converter 120, respectively. The first converter control unit 112 and the second converter control unit 122 may be a single control unit or integrated into a single control unit. The single control unit may be configured to perform operations of both the first converter control unit 122 and the second converter control unit 122. Alternatively, the first converter control unit 112 and the second converter control unit 122 are standalone units. The first converter control unit 112 and the second converter control unit 122 are configured to obtain phase currents, commonly denoted IV1 in FIG. 1, of the first voltage source converter 110 and phase currents, commonly denoted IV2, of the second voltage source converter 120. The converter station 100 further comprises a first group of current sensors CS1 configured to sense the phase currents IV1 of the first voltage source converter 110, and a second group of current sensors CS2 configured to sense the phase currents IV2 of the second voltage source converter 120. The first group of current sensors CS1 comprises three current sensors for sensing the phase currents from each phase leg (described in more detail in conjunction with FIG. 6) of the first voltage source converter 110. The second group of current sensors CS2 is similarly arranged with respect to the second voltage source converter 120. The first and second group of current sensors CS1, CS2 are connected to the first converter controller 112 as well as to the second converter controller 122. As an alternative, the first group of current sensors CS1 may be connected to merely the first converter control unit 112, and the second group of current sensors CS2 may be connected to merely the second converter control unit 122. Further, the first converter control unit 112 and the second converter control unit 122 are interconnected. The first converter control unit 112 and the second converter control unit 122 may provide the respective sensed phase currents IV1 and IV2 to each other.

The first converter control unit 112 and the second converter control unit 122 further comprises a first damping controller 114 and a second damping controller 124, respectively. Each one of the first damping controller 114 and the second damping controller 124 comprises a regulator 116, 126. The first damping controller 114 is configured to determine first current differences by subtracting the phase currents IV2 of the second voltage source converter 120 from the phase currents IV1 of the first voltage source converter 110. The second damping controller 124 is configured to determine second current differences by subtracting the phase currents IV1 of the first voltage source converter 110 from the corresponding phase currents IV2 of the second voltage source converter 120. The first and second damping controllers 114, 124 are configured to multiply each of the first current differences and the second current differences, respectively, with a respective gain for generating first damping control signals ΔUV_ORD_1 and second damping control signals ΔUV_ORD_2, respectively. The gain is introduced by the respective regulators 116, 126 in the first damping controller 114 and the second damping controller 124. The gain introduced by the regulator 116 in the first damping controller 114 is a variable relation between the first current differences and the first damping control signals ΔUV_ORD_1, which are voltages, the gain thus resembling a first virtual resistance. Similarly, the gain introduced by the regulator 126 in the second damping controller 124 ΔUV_ORD_2 resembles a second virtual resistance. For example, when the damping controller 114, 124 is a proportional (P) controller, i.e. the regulator 116, 126 is a P regulator, the variable virtual resistance is the proportional gain. The regulators 116, 126 of the first damping controller 114 and the second damping controller 124 may be configured to have equal gain, i.e. equal virtual resistance. The first converter control unit 112 is further configured to combine each of the first damping control signals ΔUV_ORD_1 with a converter reference voltage UV_ORD_1 of the first voltage source converter 110, in order to provide modified converter reference voltages UV_ORD_NEW_1 for the first voltage source converter 110. The second converter control unit 122 is further configured to combine each of the second damping control signals ΔUV_ORD_2 with a converter reference voltage UV_ORD_2 of the second voltage source converter 120 in order to provide modified converter reference voltages UV_ORD_NEW_2 for the second voltage source converter 120. The converter reference voltages UV_ORD_1, UV_ORD_2 may be generated by an external device and received at the respective converter control units 112, 122. Alternatively, the converter reference voltages UV_ORD_1 and UV_ORD_2 may be generated internally of the respective converter control units 112, 122. In the latter case, each of the converter control units 112, 122 may include a respective waveform control module that generates the respective converter reference voltages, UV_ORD_1 and UV_ORD_2. The first voltage source converter 110 and the second voltage source converter 120 are provided with the respective modified converter reference voltages, UV_ORD_NEW_1 and UV_ORD_NEW_2.

As it is known from the prior art, when both the converters 110, 120, which are connected to the same AC bus, are operating at no inner current control such as frequency voltage control, virtual synchronous machine control or grid forming control, the low frequency current components including DC component can be easily excited and flow on the low impedance circuit path, which is from one converter directly to another converter on the AC side, and two poles on the DC side The modified converter reference voltages UV_ORD_NEW_1 for the first voltage source converter 110 and the modified converter reference voltages UV_ORD_NEW_2 for the second voltage source converter 120 are used to reduce or eliminate the deviations in the converter station 100. Thereby, the oscillations in the converter station 100 or between the first voltage source converter 110 and the second voltage source converter 120 are reduced or eliminated without affecting the active and reactive power exchange between the AC system and respective converter 110, 120.

Referring to FIG. 6, according to an embodiment of the converter station, the first voltage source converter 110 comprises three phase legs, PL1, PL2 and PL3. Each phase leg PL1, PL2, PL3 comprises an upper arm and a lower arm, which in turn comprises a first converter valve CVA1, CVB1, CVC1 and a second converter valve CVA2, CVB2, CVC2, respectively. Furthermore, the first voltage source converter 110 comprises a current sensor CS connected at a first AC terminal AC1 between the upper arm and the lower arm of the first phase leg PL1. Similarly, current sensors CS are arranged at second and third AC terminals AC2, AC3 as well, those AC terminals being provided between the upper arm and the lower arm of the second and third phase legs PL2, PL3, respectively. The current sensors CS are comprised in the above-defined first group of current sensors CS1. The current sensors are arranged to sense the individual phase currents IVa_1, IVa_2, IVa_3, below also denominated A, B, and C current components. Alternatively, current sensors may be arranged to sense the arm currents of each arm, and the phase currents are then calculated from the arm currents. The first converter control unit 112 is connected with the converter valves CVA1, CVB1, CVC1, CVA2, CVB2, CVC2. The modified converter reference voltages UV_ORD_NEW_1 comprise three modified converter reference voltages UVa_ORD_NEW_1, UVb_ORD_NEW_1, UVc_ORD_NEW_1, one for each phase A, B, and C. The first converter control unit 112 is configured to provide the modified converter reference voltage UVa_ORD_NEW_1 for phase A to the first phase leg PL1, and more particularly to the first and second converter valves CVA1, CVA2 of the first phase leg PL1. Similarly, the first converter control unit 112 is configured to provide the modified converter reference voltages UVb_ORD_NEW_1, UVc_ORD_NEW_1 for the B and C phases to the first and second converter valves CVB1, CVC1, CVB2, CVC2 of the second and third phase legs PL2, PL3. The second voltage source converter 120 is similarly implemented as the first voltage source converter 110, though not shown in FIG. 6 for reasons of simplicity.

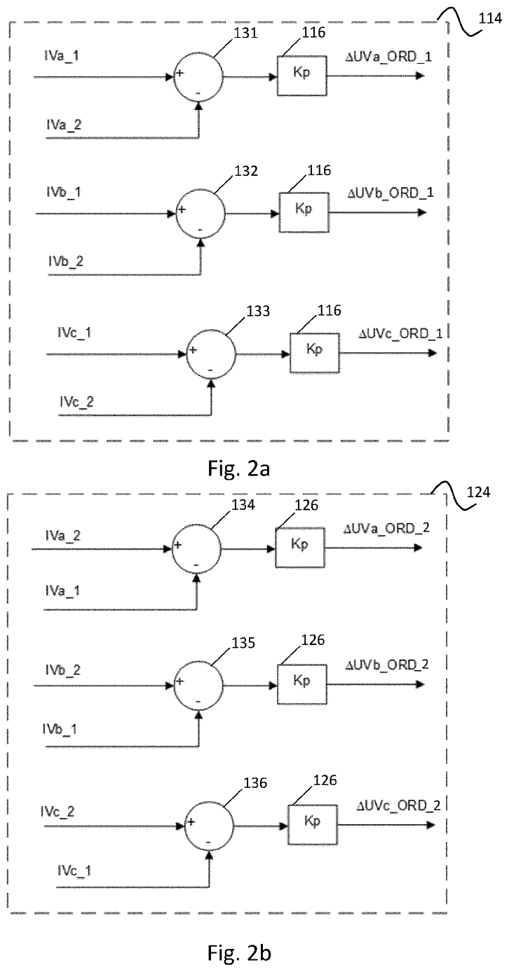

According to an embodiment of the converter station 100, as shown in FIGS. 2a and 2b the damping controllers 114, 124 are configured to operate in an ABC frame. The first damping controller 114 comprises first, second and third subtractors 131, 132, 133, which are connected with a respective input of the regulator 116. Similarly, the second damping controller 124 comprises fourth, fifth, and sixth subtractors 134, 135, 136, which are connected with respective inputs of the regulator 126. The first to third subtractors 131-133 are employed to determine the first current differences, by receiving the A current components IVa_1, IVa_2, B current components IVb_1, IVb_2, and C current components IVc_1, IVc_2, and subtracting the A, B, and C current components IVa_2, IVb_2, IVc_2 of the second voltage source converter 120 from the A, B, and C current components IVa_1, IVb_1, IVc_1 of the first voltage source converter 110. The second current differences in ABC frame are determined by means of the fourth to sixth subtractors 134-136, by subtracting the A, B, and C components IVa_1, IVb_1, IVc_1 of the first voltage source converter 110 from the A, B, and C components IVa_2, IVb_2, IVc_2 of the second voltage source converter 120.

The first damping controller 114 is further configured to multiply the A, B and C difference current components (IVa_1-IVa_2), (IVb_1-IVb_2), (IVc_1-IVc_2), thus constituting the first current differences, with the gain Kp provided by the regulator 116 to generate respective A, B and C signal components ΔUVa_ORD_1, ΔUVb_ORD_1, ΔUVc_ORD_1 constituting the first damping control signals. Similarly, the second damping controller 124 is further configured to multiply the A, B and C difference current components (IVa_2-IVa_1), (IVb_2-IVb_1), (IVc_2-IVc_1) with the gain Kp provided by the regulator 126 to generate respective A, B and C signal components ΔUVa_ORD_2, ΔUVb_ORD_2, ΔUVc_ORD_2 constituting the second damping control signals.

The gain of the regulators 116, 126 is indicated as Kp. The regulators 116, 126 are indicated to have equal gain Kp. However, person skilled in the art will understand that it is possible to have different gains for each of the first damping controller 114 and the second damping controller 124. The first damping control signals ΔUVa_ORD_1, ΔUVb_ORD_1, ΔUVc_ORD_1 and the second damping control signals ΔUVa_ORD_2, ΔUVb_ORD_2, ΔUVc_ORD_2 are then used by the first converter control unit 112 and the second converter control unit 122, respectively, to modify the converter reference voltages in the ABC frame for the first voltage source converter 110 and the second voltage source converter 120.

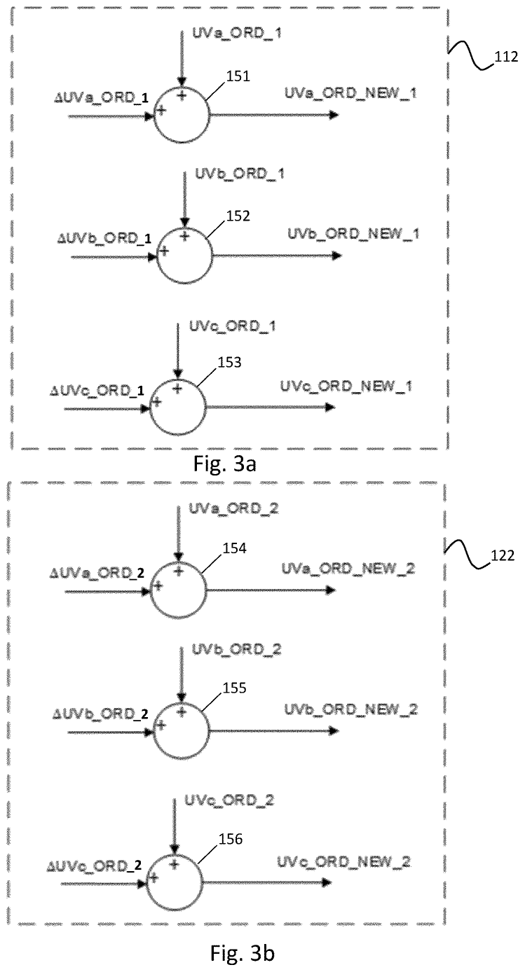

As shown in FIGS. 3a and 3b, the first converter control unit 112 and the second converter control unit 122 are configured to determine modified converter reference voltages in the ABC frame for the first voltage source converter 110 and the second voltage source converter 120, respectively. The first converter control unit 112 comprises first, second and third combiners 151, 152, 153, which are connected with the regulator 116 for receiving a respective one of the A, B, and C signal components ΔUVa_ORD_1, ΔUVb_ORD_1, ΔUVc_ORD_1. Similarly, the second converter control unit 122 comprises fourth, fifth, and sixth combiners 154, 155, 156 connected with the regulator 126 for receiving a respective one of the A, B, and C signal components ΔUVa_ORD_2, ΔUVb_ORD_2, ΔUVc_ORD_2. Additionally, the first, second and third combiners 151, 152, 153 receive corresponding A, B, and C components UVa_ORD_1, UVb_ORD_1, UVc_ORD_1 of the converter reference voltage for the first voltage source converter 110, and combine them with the respective A, B, and C signal components in order to provide A, B and C components of the modified converter reference voltage UVa_ORD_NEW_1, UVb_ORD_NEW_1, UVc_ORD_NEW_1 for the first voltage source converter 110. Similarly, the fourth, fifth, and sixth combiners 154, 155, 156 additionally receive A, B, and C components UVa_ORD_2, UVb_ORD_2, UVc_ORD_2 of the converter reference voltage for the second voltage source converter 120 and combine them with the respective A, B and C signal components ΔUVa_ORD_2, ΔUVb_ORD_2, ΔUVc_ORD_2 in order to provide A, B and C components of the modified converter reference voltage UVa_ORD_NEW_2, UVb_ORD_NEW_2, UVc_ORD_NEW_2 for the second voltage source converter 120. More particularly, in this embodiment the combining is performed as an addition. The A, B and C components, or phase voltages, UVa_ORD_NEW_1, UVb_ORD_NEW_1, UVc_ORD_NEW_1, UVa_ORD_NEW_2, UVb_ORD_NEW_2, UVc_ORD_NEW_2 of the modified converter reference voltages for the first voltage source converter 110 and the second voltage source converter 120 are respectively provided to the converter valves of first voltage source converter 110 and the second voltage source converter 120.

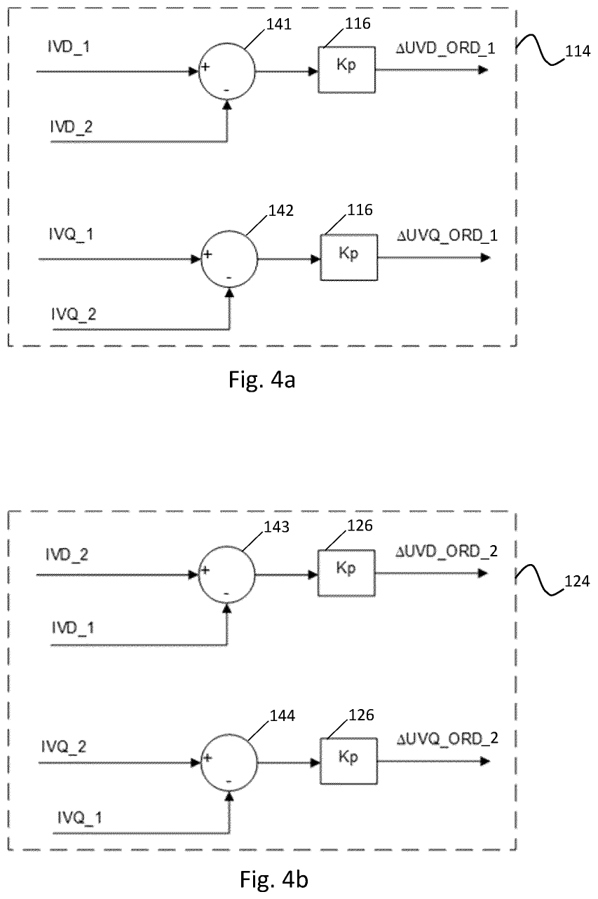

According to an embodiment of the converter station 100, as shown in FIGS. 4a and 4b the damping controllers 114, 124 are configured to operate in a DQ frame. The first damping controller 114 comprises first and second subtractors 141, 142, one for each respective pair of the D and Q components of the phase currents IV1, IV2. The first and second subtractors 141, 142, are connected with a respective input of the regulator 116. Similarly, the second damping controller 124 comprises third and fourth subtractors 143, 144, for handling the D current components, and the Q current components, respectively. The third and fourth subtractors 143, 144 are connected with respective inputs of the regulator 126. The first and second damping controllers 114, 124 are configured to determine the D current components IVD_1, IVD_2, and Q current components IVQ_1, IVQ_2, of the phase currents IV1, IV2 of the first and the second voltage source converters 110, 120. The first damping controller 114 is further configured to determine the first current differences, and the second damping controller 124 is further configured to determine the second current differences, by operating on the respective D current components and Q current components of the AC currents 11, 12 of the first and second voltage source converters 110, 120, by means of the first to fourth subtractors 141-144. The first and second current differences thereby comprising D and Q difference current components. The first current differences in DQ frame are determined by means of the first and second subtractors 141, 142, by subtracting the D, and Q components of the phase currents of the second voltage source converter 120 from the D, and Q components of the phase currents of the first voltage source converter 110, and they are expressed as (IVD_1-IVD_2) and (IVQ_1-IVQ_2). Similarly, the second current differences in DQ frame are determined by means of the third and fourth subtractors 143, 144, by subtracting the D, and Q components of the phase currents of the first voltage source converter 110 from the DQ components of the phase currents of the second voltage source converter 120, and they are expressed as (IVD_2-IVD_1) and (IVQ_2-IVQ_1).

The first damping controller 114 is further configured to multiply the D and Q difference current components, (IVD_1-IVD_2) and (IVQ_1-IVQ_2), constituting the first current differences, with the gain Kp provided by the regulator 116 to generate respective D and Q signal components ΔUVD_ORD_1, ΔUVQ_ORD_1 constituting the first damping control signals. Similarly, the second damping controller 124 is further configured to multiply the D and Q difference current components (IVD_2-IVD_1) and (IVQ_2-IVQ_1) with the gain Kp provided by the regulator 126 to generate respective D and Q signal components ΔUVD_ORD_2, ΔUVQ_ORD_2 constituting the second damping control signals.

The gain of the regulators 116, 126 is indicated as Kp. The regulators 116, 126 are indicated to have equal gain Kp. However, person skilled in the art will understand that it is possible to have different gains for each of the first damping controller 114 and the second damping controller 124. The first damping control signals ΔUVD_ORD_1, ΔUVQ_ORD_1 and the second damping control signals ΔUVD_ORD_2, ΔUVQ_ORD_2 are then used by the first converter control unit 112 and the second converter control unit 122, respectively, to modify the converter reference voltages in the DQ frame for the first voltage source converter 110 and the second voltage source converter 120.

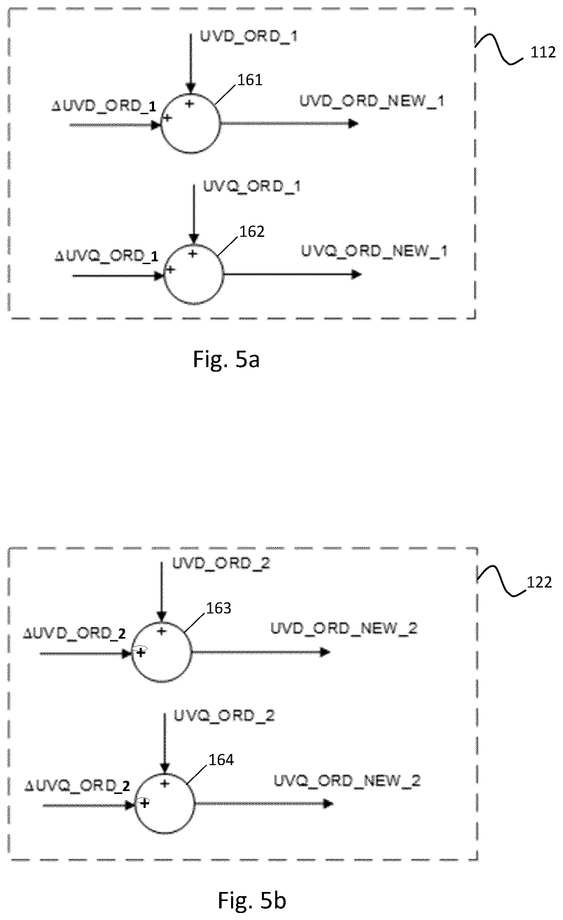

As shown in FIGS. 5a and 5b the first converter control unit 112 and the second converter control unit 122 are configured to determine modified converter reference voltages in the DQ frame for the first voltage source converter 110 and the second voltage source converter 120, respectively. The first converter control unit 112 comprises first, and second combiners 161, 162 connected with the regulator 116 for receiving a respective one of the D and Q signal components ΔUVD_ORD_1, ΔUVQ_ORD_1. Similarly, the second converter control unit 122 comprises third and fourth combiners 163, 164 connected with the regulator 126 for receiving a respective one of the D and Q signal components ΔUVD_ORD_2, ΔUVQ_ORD_2. Additionally, the first and second combiners 161, 162 receive corresponding D and Q components UVD_ORD_1, UVQ_ORD_1 of the converter reference voltage for the first voltage source converter 110, and combine them with the respective D and Q signal components in order to provide D and Q components of the modified converter reference voltage UVD_ORD_NEW_1, UVQ_ORD_NEW_1 for the first voltage source converter 110. Similarly, the third and fourth combiners 163, 164 additionally receive D and Q components UVD_ORD_2, UVQ_ORD_2 of the converter reference voltage for the second voltage source converter 120 and combine them with the respective D and Q signal components ΔUVD_ORD_2, ΔUVQ_ORD_2 in order to provide D and Q components of the modified converter reference voltage UVD_ORD_NEW_2, UVQ_ORD_NEW_2 for the second voltage source converter 120.

More particularly, in this embodiment the combining is performed as an addition, i.e. the first to fourth combiners 161-164 are adders.

The D and Q components of the modified converter reference voltage for the first voltage source converter 110 and for the second voltage source converter 120 are then transformed back to ABC frame by the first and second converter control units 112, 122 and provided as phase voltages UVa_ORD_NEW_1, UVb_ORD_NEW_1, UVc_ORD_NEW_1, UVa_ORD_NEW_2, UVb_ORD_NEW_2, UVc_ORD_NEW_2 to the converter valves of the first and second voltage source converters 110, 120.

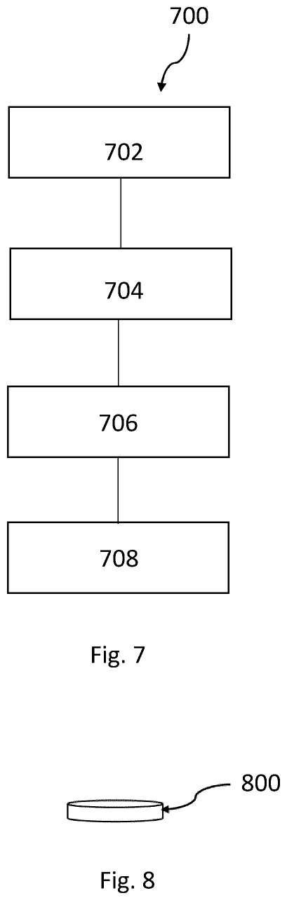

FIG. 7 shows a flow chart for a method 700 for controlling a converter station comprising at least two converters, including a first voltage source converter and a second voltage source converter. The converter station is configured to be connected to a DC system and to an AC system. The DC system has two poles and the AC system has multiple phases. The first voltage source converter and the second voltage source converter are connectable to a respective one of the two poles and are connected to each other.

The method 700 for controlling a converter station comprises, in box 702, receiving phase currents of the first voltage source converter and phase currents of the second voltage source converter. Further the method comprises, in box 704, determining first current differences by subtracting the phase currents of the second voltage source converter from the phase currents of the first voltage source converter, and determining second current differences by subtracting the phase currents of the first voltage source converter from the phase currents of the second voltage source converter. The method further comprises multiplying each of the first current differences and the second current differences, respectively, with a respective gain for generating first damping control signals and second damping control signals, respectively, in box 706. Furthermore, in box 708, the method comprises combining the first damping control signals with a converter reference voltage of the first voltage source converter and combining the second damping control signals with a converter reference voltage of the second voltage source converter, thereby providing respective modified converter reference signals for the first voltage source converter and the second voltage source converter.

In an embodiment, alternatively or additionally, the method 700 for controlling a converter station, may further comprise, in box 704, determining or receiving DQ frame components of the phase currents, in particular, determining the D current component IVD_1 and Q current component IVQ_1 of the phase currents of the first voltage source converter 110. Further, determining the D current component IVD_2 and Q current component IVQ_2 of the phase currents of the second voltage source converter 120, and determining the first current differences and the second current differences by operating on respective D current components and Q current components of the first and the second voltage source converters. Determining the differences may comprise determining the first current difference (IVD_1-IVD_2), (IVQ_1-IVQ_2) between the D components of the phase currents and between the Q components of the phase currents. Determining the differences may further comprise determining the second current differences (IVD_2-IVD_1), (IVQ_2-IVQ_1) between the D components of the phase currents and between the Q components of the phase currents. The method may further comprise, in box 706, multiplying the first current differences (IVD_1-IVD_2), (IVQ_1-IVQ_2) with a respective gain to generate the first damping control signal ΔUVD_ORD_1, ΔUVQ_ORD_1 for each component. Further, multiplying the second current differences (IVD_2-IVD_1), (IVQ_2-IVQ_1) with a respective gain to generate the second damping control signal ΔUVD_ORD_2, ΔUVQ_ORD_2 for each component. The combining, in box 708, may further comprise combining the D and Q components ΔUVD_ORD_1, ΔUVQ_ORD_1 of the first damping control signals with D and Q components UVD_ORD_1, UVQ_ORD_1 of the converter reference voltage of the first voltage source converter 110, and combining the D and Q components ΔUVD_ORD_2, ΔUVQ_ORD_2 of the second damping control signals with D and Q components UVD_ORD_2, UVQ_ORD_2 of the converter reference voltage of the second voltage source converter 120 to provide the respective modified converter reference signals UVD_ORD_NEW_1, UVQ_ORD_NEW_1, UVD_ORD_NEW_2, UVQ_ORD_NEW_2 in the DQ frame for the first voltage source converter 110 and the second voltage source converter 120.

In yet another embodiment, the method 700 for controlling a converter station may further comprise, in box 704, the individual phase currents directly, i.e. the A current component IVa_1, the B current component IVb_1 and the C current component IVc_1 of the phase currents of the first voltage source converter 110, and the A current component IVa_2, the B current component IVb_2, and the C current component IVc_2 of the phase currents of the second voltage source converter 120. Thus, determining the first and second current differences comprises determining first and second A, B, and C component differences between the A, B, and C current components (IVa_1-IVa_2), (IVb_1-IVb_2), (IVc_1-IVc_2), (IVa_2-IVa_1), (IVb_2-IVb_1), (IVc_2-IVc_1). The multiplying, box 706, may further comprise multiplying the first A, B, and C component differences (IVa_1-IVa_2), (IVb_1-IVb_2), (IVc_1-IVc_2), respectively with the gain to generate the first damping control signals ΔUVa_ORD_1, ΔUVb_ORD_1, ΔUVc_ORD_1. And further multiplying the second A, B, and C component differences (IVa_1-IVa_2), (IVb_1-IVb_2), (IVc_1-IVc_2), respectively, with a gain to generate the second damping control signals ΔUVa_ORD_2, ΔUVb_ORD_2, ΔUVc_ORD_2. The operation of combining, box 708, further comprises, for each component in the ABC frame, combining the respective A, B and C components of the damping control signals with corresponding A, B and C components of the respective converter reference voltages to provide the respective modified converter reference signals in the ABC frame for the first voltage source converter 110 and the second voltage source converter 120. The first damping control signals ΔUVa_ORD_1, ΔUVb_ORD_1, ΔUVc_ORD_1 are combined with corresponding A, B, and C components of the converter reference voltage UVa_ORD_1, UVb_ORD_1, UVc_ORD_1 in the ABC frame for the first voltage source converter in order to provide the modified converter reference voltage UVa_ORD_NEW_1, UVb_ORD_NEW_1, UVc_ORD_NEW_1 for the first voltage source converter 110. Similarly, the second damping control signals ΔUVa_ORD_2, ΔUVb_ORD_2, ΔUVc_ORD_2 are combined with corresponding A, B, and C components of the converter reference voltage UVa_ORD_2, UVb_ORD_2, UVc_ORD_2 for the second voltage source converter 120 in order to provide the modified converter reference voltages UVa_ORD_NEW_2, UVb_ORD_NEW_2, UVc_ORD_NEW_2 for the second voltage source converter 120. FIG. 8 most schematically illustrates that as an aspect of the present disclosure, there is provided a computer program product 800 comprising instructions which, when downloaded into and/or executed by a device having processing capability, for instance a converter station, causes the device to carry out the method set forth above.

The person skilled in the art realizes that the present invention by no means is limited to the preferred embodiments described above. On the contrary, many modifications and variations are possible within the scope of the appended claims. For example, the converter control units performing the modification of the converter reference voltages for the voltage source converters are shown as separate independent devices. However, they can be provided as a single converter control unit performing all the functions of the independent converter units, or as multiple converter control units. Thus, the embodiments presented in the disclosure are for exemplary purpose and should not be construed as limiting the scope.

1. A converter station comprising at least two converters, including a first voltage source converter and a second voltage source converter,
wherein the converter station is configured to be connected to a direct current (DC) system and to an alternating current (AC) system, wherein the DC system has two poles and the AC system has multiple phases, and
wherein the first voltage source converter and the second voltage source converter are connectable to a respective one of the two poles and are connected to each other;
the converter station further comprising a first converter control unit and a second converter control unit connected to the first voltage source converter and to the second voltage source converter, respectively,
wherein the first converter control unit and the second converter control unit are configured to obtain phase currents of the first voltage source converter and phase currents of the second voltage source converter,
wherein the first converter control unit and the second converter control unit further comprises a first damping controller and a second damping controller, respectively,
wherein each one of the first damping controller and the second damping controller comprises a regulator,
wherein the first damping controller is configured to determine first current differences between the phase currents of the first and second voltage source converters, and the second damping controller is configured to determine second current differences between the phase currents of the first and second voltage source converters, wherein the first damping controller is configured to determine the first current differences by subtracting the phase currents of the second voltage source converter from the phase currents of the first voltage source converter, and the second damping controller is configured to determine the second current differences by subtracting the phase currents of the first voltage source converter from the phase currents of the second voltage source converter,
wherein the first and second damping controllers are configured to multiply the first current differences and the second current differences, respectively, with a respective gain for generating first damping control signals and second damping control signals, respectively, wherein the gain introduced by means of the regulator, and
wherein the first converter control unit is further configured to combine the first damping control signals with a converter reference voltage of the first voltage source converter and the second converter control unit is further configured to combine the second damping control signals with a converter reference voltage of the second voltage source converter, in order to provide respective modified converter reference voltages for the first voltage source converter and the second voltage source converter.

2. (canceled)

3. The converter station according to claim 1, wherein the first and second damping controllers are configured to operate in a DQ frame, wherein the first damping controller further is configured to determine the first current differences and the second damping controller is further configured to determine the second current differences by operating on respective D current components and Q current components of the phase currents of the first and the second voltage source converters, the first and second current differences thereby comprising D and Q difference current components.

4. The converter station according to claim 3, wherein the first and second damping controllers are configured to multiply the D and Q difference current components with the respective gain provided by the regulators to generate the respective first and second damping control signals in DQ frame.

5. The converter station according to claim 4, wherein the first converter control unit and the second converter control unit are configured to combine the respective first and second damping control signals in DQ frame with the respective converter reference voltages in DQ frame for each of the first voltage source converter and the second voltage source converter in order to provide the respective modified converter reference voltages for the first voltage source converter and the second voltage source converter.

6. The converter station according to claim 1, wherein the first and second damping controllers are configured to operate in a ABC frame, wherein the first damping controller is configured to determine the first current differences and the second damping controller is further configured to determine the second current differences by operating on respective A current components, B current components and C current components of the phase currents of the first and the second voltage source converters, the first and second current differences thereby comprising A, B, and C difference current components.

7. The converter station according to claim 6, wherein the first and second damping controllers are configured to multiply the A, B, and C difference current components with the gain provided by the regulators to generate the respective first and second damping control signals in ABC frame.

8. The converter station according to claim 7, wherein the first converter control unit and the second converter control unit are configured to combine A, B, and C components of the respective first and second damping control signals with the corresponding A, B, and C components of the respective converter reference voltages for each of the first voltage source converter and the second voltage source converter in order to provide the respective modified converter reference voltages for the first voltage source converter and the second voltage source converter.

9. A method for controlling a converter station comprising at least two converters, including a first voltage source converter and a second voltage source converter, wherein the converter station is configured to be connected to a DC system and to an AC system, wherein the DC system has two poles and the AC system has multiple phases, and wherein the first voltage source converter and the second voltage source converter are connectable to a respective one of the two poles and are connected to each other, the method comprising:
obtaining phase currents of the first voltage source converter and phase currents of the second voltage source converter,
determining first current differences between the phase currents of the first and second voltage source converters, and second current differences between the phase currents of the first and second voltage source converters, wherein determining the first current differences and the second current differences comprises determining the first current differences by subtracting the phase currents of the second voltage source converter from the phase currents of the first voltage source converter, and determining the second current differences by subtracting the phase currents of the first voltage source converter from the phase currents of the second voltage source converter,
multiplying each of the first current differences and the second current differences, respectively, with a respective gain for generating first damping control signals and second damping control signals, respectively, and
combining the first damping control signals with a converter reference voltage of the first voltage source converter and combining the second damping control signals with a converter reference voltage of the second voltage source converter, thereby providing respective modified converter reference signals for the first voltage source converter and the second voltage source converter.

10. (canceled)

11. The method for controlling a converter station according to claim 9, comprising determining DQ frame components of the phase currents, wherein determining the first current differences and the second current differences comprises determining the difference between D current components of the phase currents and determining the difference between Q current components of the phase currents; wherein the combining comprises combining the D and Q components of the first damping control signals with D and Q components of the converter reference voltage of the first voltage source converter, and combining the D and Q components of the second damping control signals with D and Q components of the converter reference voltage of the second voltage source converter.

12. The method for controlling a converter station according to claim 11, wherein combining the D and Q components of the first damping control signal with D and Q components of the converter reference voltage of the first voltage source converter comprises adding the D and Q components of the first damping control signal to the D and Q components of the converter reference voltage, and wherein combining the D and Q components of the second damping control signal with D and Q components of the converter reference voltage of the second voltage source converter comprises adding the D and Q components of the second damping control signal in the DQ frame to the D and Q components of the converter reference voltage.

13. The method for controlling a converter station according to claim 9, wherein determining the first current differences and the second current differences comprises determining the difference between A current components of the phase currents, determining the difference between B current components of the phase currents and determining the difference between C current components of the phase currents; wherein the combining comprises combining the respective A, B, and C components of the damping control signals with corresponding A, B, and C components of the respective converter reference voltage.

14. The method for controlling a converter station according to claim 9, wherein the operation of multiplying each of the first current difference and the second current difference, respectively, with a respective gain further comprises applying an equal gain.

15. A non-transitory computer-readable medium having a computer program product stored thereon, the computer program product comprising computer readable instructions which, when executed by a device having processing capability, causes the device to carry out the method of claim 9.
